(19) United States
(12) Patent Application Publication
(10) Pub. No.: US 2014/0322486 A1
(43) Pub. Date: Oct. 30, 2014

(54) METHOD FOR PREPARING MODIFIED SILICA FILM, COATING LIQUID FOR THE SAME AND MODIFIED SILICA FILM PREPARED FROM THE SAME

(71) Applicant: Shigeto KOBORI, Kanagawa (JP)

(72) Inventor: Shigeto KOBORI, Kanagawa (JP)

(21) Appl. No.: 14/262,010

(22) Filed: Apr. 25, 2014

(30) Foreign Application Priority Data
Apr. 30, 2013 (JP) 2013-095965
Jul. 26, 2013 (KR) 10-2013-0089177

(51) Int. Cl. C09D 1/00; G02B 1/10

(52) U.S. Cl. CPC C09D 1/00; G02B 1/105
USPC 428/141; 427/162; 106/287.27; 428/446; 428/213

(57) ABSTRACT

A method for preparing a one-packing type modified silica film and a modified silica film, the method including preparing a polysilazane solution by dissolving polysilazane in a solvent for polysilazane; preparing a coating liquid by mixing fluorine-containing particles in the polysilazane solution, the fluorine-containing particles having a non-reactive functional group that does not react with polysilazane; forming a coating layer by coating the coating liquid onto a substrate; removing the solvent for polysilazane from the coating layer; and converting the polysilazane into silica.

### CROSS-REFERENCE TO RELATED APPLICATION

Japanese Patent Application No. 2013-095965, filed on Apr. 30, 2013, in the Japanese Intellectual Property Office, and entitled: “METHOD FOR PREPARING MODIFIED SILICA FILM, COATING LIQUID FOR THE SAME AND MODIFIED SILICA FILM PREPARED FROM THE SAME,” is incorporated by reference herein in its entirety.

Korean Patent Application No. 10-2013-0089177, filed on Jul. 26, 2013, in the Korean Intellectual Property Office, and entitled: “METHOD FOR PREPARING MODIFIED SILICA FILM, COATING LIQUID FOR THE SAME AND MODIFIED SILICA FILM PREPARED FROM THE SAME,” is incorporated by reference herein in its entirety.

### BACKGROUND

1. Field

Embodiments relate to a method for preparing a modified silica film, a coating liquid, and a modified silica film.

2. Description of the Related Art

A silica film prepared by silica conversion (e.g., curing) of polysilazane may exhibit strength close to that of glass, and the silica film may be used to improve surface strength of various films.

### SUMMARY

Embodiments are directed to a method for preparing a modified silica film, a coating liquid, and a modified silica film.

The embodiments may be realized by providing a method for preparing a one-packing type modified silica film, the method including providing a polysilazane solution, the polysilazane solution having polysilazane dissolved in a solvent for polysilazane; providing a coating liquid by mixing fluorine-containing particles in the polysilazane solution, the fluorine-containing particles having a non-reactive functional group that does not react with polysilazane; forming a coating layer by coating the coating liquid onto a substrate; removing the solvent for polysilazane from the coating layer; and converting the polysilazane into silica.

The fluorine-containing particles may have a lower surface tension than the solvent for polysilazane.

The fluorine-containing particles may include a multi-branched fluorine polymer.

A weight ratio of the polysilazane to the fluorine-containing particles may be about 95:5 to about 60:40.

The non-reactive functional group may be a (per)fluoroalkyl group or a (per)fluoropolyether group.

The embodiments may be realized by providing a one-packing type modified silica film prepared by the method according to an embodiment.

The embodiments may be realized by providing a one-packing type modified silica film including a low refractive index layer, the low refractive index layer including silica that has been converted from polysilazane and fluorine-containing particles having a non-reactive functional group that does not react with polysilazane.

The modified silica film may further include a protective layer on a surface of the low refractive index layer, the protective layer having a higher concentration of the fluorine-containing particles than the low refractive index layer.

The protective layer may have an average surface roughness of about 6.5 nm to about 15.0 nm.

A concentration of the fluorine-containing particles in the modified silica film may increase as a distance from a lower surface of the low refractive index layer to an outer surface of the protective layer increases.

The protective layer includes silica that has been converted from polysilazane, and the low refractive index layer may include a greater amount of silica than the protective layer.

A concentration of the silica in the modified silica film may decrease as a distance from a lower surface of the low refractive index layer to an outer surface of the protective layer increases.

The modified silica film may include about 60 wt % to about 95 wt % of the silica, and about 5 wt % to about 40 wt % of the fluorine-containing particles.

The low refractive index layer may have a thickness that is about 80% to about 99.8% of a total thickness of the modified silica film, and the protective layer may have a thickness that is about 0.2% to about 20% of the total thickness of the modified silica film.

The modified silica film may have a pencil hardness of H or harder, and a contact angle of about 110.3° or higher.

The modified silica film may be prepared from a coating liquid, the coating liquid including the fluorine-containing particles and a polysilazane solution prepared by dissolving polysilazane in a solvent for polysilazane, the fluorine-containing particles having a lower surface tension than the solvent for polysilazane.

A weight ratio of the polysilazane to the fluorine-containing particles in the coating liquid may be about 95:5 to about 60:40.

A difference in surface tension between the solvent for polysilazane and the fluorine-containing particles may be about 3.8 mN/m or more.

### BRIEF DESCRIPTION OF THE DRAWINGS

Features will be apparent to those of skill in the art by describing in detail exemplary embodiments with reference to the attached drawings in which:

FIG. 1 illustrates a diagram showing an overview of a method for preparing a modified silica film and a modified silica film according to one embodiment.

FIG. 2 illustrates a diagram of a coating liquid according to one embodiment.

FIG. 3 illustrates a diagram of a structure of fluorine particles according to one embodiment.

FIG. 4 illustrates a diagram showing a structure of a modified silica film.

FIG. 5 illustrates a diagram showing a structure of a tester used for a pencil rubbing test.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

Herein, surface tension is a value at 25° C. and is given in mN/m. Surface tension is measured, for example, by an automatic surface tensiometer (DY-300, Kyoa Interface Science Co., Ltd.). In the following examples, surface tension was measured using a DY-300 (Kyoa Interface Science Co., Ltd.).

Method for Preparing Modified Silica Film

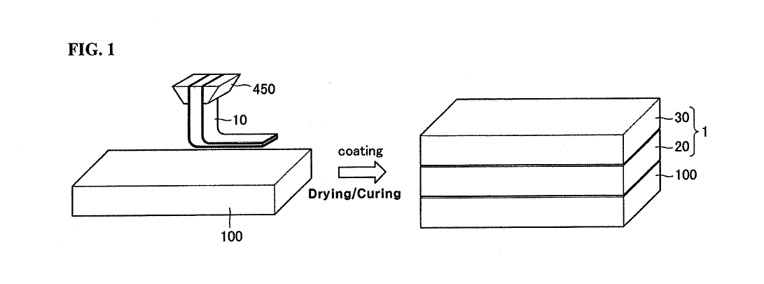

First, referring to FIGS. 1 to 3, a method for preparing a modified silica film according to one embodiment will be described in detail. The method for preparing a modified silica film according to the embodiment may be a method for preparing a one-packing type modified silica film. The “one-packing type modified silica film” may refer to a modified silica film formed by coating a single coating liquid, which may be prepared by mixing a polysilazane solution with fluorine-containing particles, e.g., fluorine particles, onto a substrate. The method for preparing a modified silica film according to this embodiment may include first to six operations.

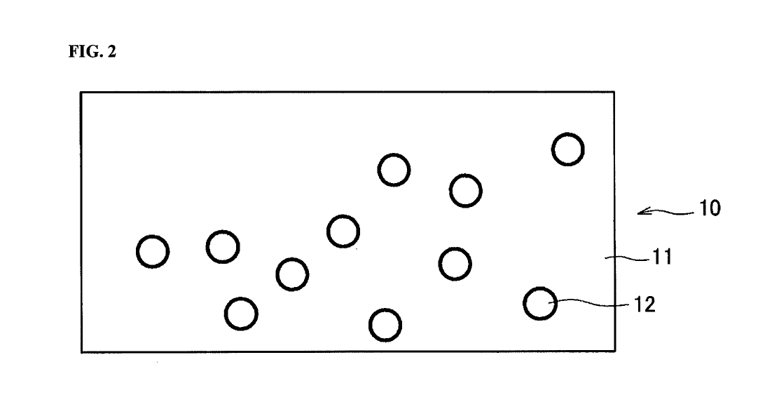

In the first operation, a polysilazane solution 11 may be prepared by dissolving polysilazane in a solvent for polysilazane (e.g., a solvent suitable for dissolving polysilazane), as shown in FIG. 2. In the second operation, a coating liquid 10 may be prepared by mixing the polysilazane solution 11 with fluorine particles 12.

In the third operation, a coating layer may be formed by coating the coating liquid 10 onto a substrate 100, as shown in FIG. 1. The coating layer may be formed of the coating liquid 10. In the fourth operation, the solvent for polysilazane may be removed from the coating layer. In the fifth operation, the polysilazane may be converted into silica. Through these operations, a modified silica film 1 may be formed on the substrate 100. The modified silica film 1 may include a low refractive index layer 20 and a protective layer 30. For example, in this embodiment, the low refractive index layer 20 and the protective layer 30 may be formed by coating the coating liquid 10 in or as a single layer. Hereinafter, each operation will be described in more detail.

First Operation

In the first operation, the polysilazane solution 11 may be prepared by dissolving the polysilazane in the solvent for polysilazane.

The polysilazane is an inorganic polymer that is also referred to as perhydropolysilazane, and may have a structure represented by Formula 1:

(SiH₂NH)ₙ (1)

In Formula 1, n may be a natural number, e.g., about 4 to about 2,000.

The polysilazane may have as low a weight average molecular weight as possible. Maintaining a suitably low weight average molecular weight of the polysilazane may help reduce and/or prevent precipitation of crystals of the polysilazane in the polysilazane solution 11.

The solvent for polysilazane is a solvent for dissolving polysilazane. The solvent for polysilazane may have higher surface tension than the fluorine particles 12. Maintaining the surface tension of the solvent for polysilazane higher than that of the fluorine particles 12 may help ensure that the fluorine particles 12 in the coating layer are able to bleed to or aggregate at a surface of the coating layer. For example, the fluorine particles 12 may be attracted to air.

The solvent for polysilazane and the fluorine particles 12 may have as large a difference in surface tension therebetween as possible. The increased difference in surface tension may help facilitate bleeding to or aggregating of the fluorine particles 12 at the surface of the coating layer. In an implementation, the difference in surface tension may be about 3.8 mN/m or more, e.g., from about 3.8 mN/m to about 17 mN/m, as calculated by subtracting the surface tension of the fluorine particles 12 from the surface tension of the solvent for polysilazane.

The solvent for polysilazane (satisfying the above requirement) may include, e.g., a hydrophobic and non-polar organic solvent. Examples of such an organic solvent may include dibutyl ether, xylene, mineral turpentine, petroleum hydrocarbons, and high-boiling point aromatic hydrocarbons. The boiling point of the high-boiling point aromatic hydrocarbons may be from about 110° C. to about 180° C., e.g., from about 120° C. to about 160° C. In an implementation, the solvent for polysilazane may include, e.g., dibutyl ether, xylene, mineral turpentine, petroleum hydrocarbons, or high-boiling point aromatic hydrocarbons. Dibutyl ether has a surface tension of about 22.4, xylene has a surface tension of about 30.0, and mineral turpentine has a surface tension of about 25.0.

In an implementation, the polysilazane solution 11 may include a suitable additive that does not deteriorate polysilazane. For example, the polysilazane solution 11 may include an amine catalyst. If the polysilazane solution 11 includes the amine catalyst, silica conversion of polysilazane may be performed at room temperature. Although the polysilazane may also be converted into silica when heated to about 300° C. to about 400° C., an optical film provided as a substrate may be sensitive to thermal stress. Thus, for example, in order to help prevent the optical film from suffering from thermal stress, the amine catalyst may be added to the polysilazane solution 11.

The solvent for polysilazane may have as low a moisture content as possible. For example, the moisture content of the solvent for polysilazane refers to a percent of water expressed in % by weight (wt %) based on a total weight of the solvent for polysilazane. In an implementation, the solvent for polysilazane may have a moisture content of less than about 1 wt %, e.g., closer to 0 wt %. Moisture in the solvent for polysilazane may cause silica conversion of polysilazane. Such silica conversion may deteriorate the quality of the modified silica film 1.

Second Operation

In the second operation, the coating liquid 10 may be prepared by mixing the polysilazane solution 11 with the fluorine particles 12.

The fluorine particles 12 may be added to the polysilazane solution 11 in order to help reduce the index of refraction of the low refractive index layer 20 and to impart antifouling properties, slidability, and scratch resistance to the protective layer 30. The fluorine particles 12 may be nanometer-scale fluorinated spherical polymers. For example, the fluorine particles 12 may be fine functional particles having a large number of terminal groups. In addition, the fluorine particles 12 may repel the polysilazane solution. For example, the fluorine particles 12 may have a non-reactive functional group that does not react with polysilazane. In an implementation, the fluorine particles 12 may have a small number of reactive functional groups reacting with polysilazane, and the fluorine particles 12 may have as few of these reactive functional groups as possible.

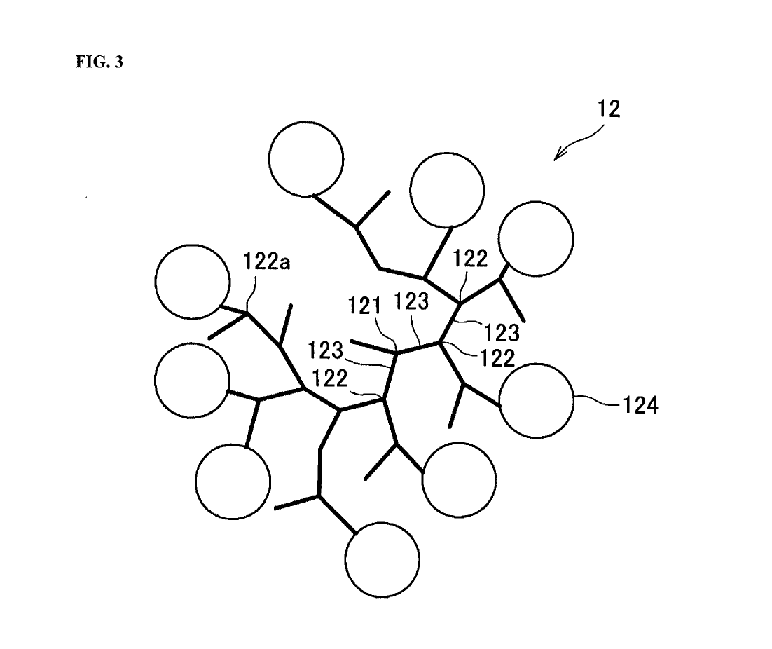

Referring to FIG. 3, one example of a structure of the fluorine particle 12 will be described in detail. The fluorine particle 12 may include a core 121, a plurality of branch points 122, a plurality of branches 123, and a plurality of terminal groups 124. The core 121 may be a central portion of the fluorine particle 12, and may be bonded to at least one branch 123. The core 121 may be composed of mostly or entirely a single element, or may be composed of an organic residue. The single element may include, e.g., carbon, nitrogen, silicon, phosphorus atoms, or the like. In an implementation, the organic residue may include various branched compounds and/or cyclic compounds. In an implementation, the fluorine particle 12 may include a plurality of the cores 121.

The branch point 122 may be a starting point of the branches 123, and at least two branches 123 may extend from one branch point 122. The branch point 122 may be connected to the core 121 or to another branch point 122 via the branch 123. For example, the branch points 122 may be composed of entirely or mostly a single element, or may be composed of an organic residue. The branch points 122 may be referred to as first generation, second generation, . . . , in order from the closest one to the core 121, respectively. For example, the branch point 122 directly connected to the core 121 may correspond to the first generation, and the branch point 122 connected to the branch point 122 of the first generation may correspond to the second generation.

In an implementation, the fluorine particles 12 may include the branch point 122 of at least second generation. For example, in one example shown in FIG. 3, the fluorine particle 12 may include a branch point 122a of the fifth generation.

The branches 123 may connect the branch point 122 of the k-th generation (where k is an integer of 1 or more) to the branch point 122 of the (k+1)-th generation and may connect the core 121 to the branch point 122 of the first generation. The branches 123 may be bonding hands included in the core 121 or the branch points 122. In an implementation, it may be desirable that the branch points have a large number of generations. For example, as the number of generations increases, the fluorine particles 12 may have improved strength, and the protective layer 30 may have improved properties in terms of antifouling properties, slidability, and scratch resistance.

The terminal groups 124 may be fluorine-containing functional groups. For example, the terminal group 124 may include a (per)fluoroalkyl group, a (per)fluoropolyether group, or the like. The fluorine-containing functional groups may be functional groups that do not react with polysilazane.

The (per)fluoroalkyl group may have a suitable structure. For example, the (per)fluoroalkyl group may have a linear structure (e.g., —CF₂CF₃, —CH₂(CF₂)₄H, —CH₂(CF₂)₈CF₃, —CH₂CH₂(CF₂)₄H, and the like), a branched structure (e.g., CH(CF₃)₂, CH₂CF(CF₃)₂, CH(CH₃)CF₂CF₂CF₃, CH(CH₃)(CF₂)₅CF₂H, or the like), or an alicyclic structure (five-membered or six-membered cyclic structure, e.g., a perfluorocyclohexyl group, a perfluorocyclopentyl group, an alkyl group substituted therewith, or the like).

The (per)fluoropolyether group may be a (per)fluoroalkyl group having an ether linkage, and may have a suitable structure. For example, the (per)fluoropolyether group may include CH₂OCH₂CF₂CF₃, CH₂CH₂OCH₂C₄F₈H, CH₂CH₂OCH₂CH₂C₈F₁₇, CH₂CH₂OCF₂CF₂OCF₂CF₂H, a C₄ to C₂₀ fluorocycloalkylether group including at least five fluorine atoms, or the like. In an implementation, the (per)fluoropolyether group may include (CF₂)ₓO(CF₂CF₂O)_{y}, [CF(CF₃)CF₂O]ₓ—[CF₂(CF₃)], (CF₂CF₂CF₂O)ₓ, (CF₂CF₂O)ₓ, or the like. Here, x and y are any natural number.

In this way, the fluorine particle 12 may include fluorine functional groups as the terminal groups 124, and a surface of the fluorine particle 12 may be substantially covered with the fluorine functional groups. Thus, the fluorine particles 12 may exhibit excellent antifouling properties and slidability while forming an extremely robust bulk body. In addition, the fluorine particle 12 may be a multi-branched polymer, and the fluorine particle 12 may exhibit excellent elasticity. In an implementation, the fluorine particles 12 may bleed to the surface of the coating layer, and the modified silica film 1 may have significantly improved properties in terms of antifouling properties, slidability, and scratch resistance.

The terminal groups of the fluorine particles may not include a reactive functional group that is reactive with the polysilazane, e.g., a C₁ to C₄ alkoxy group or a silanol group (hydroxyl group). Thus, the fluorine particles may bleed to the surface of the coating layer without reacting with the polysilazane in the coating liquid.

In an implementation, the fluorine particles 12 may include a plurality of orifices therein, and air may enter the orifices. Further, the fluorine particle 12 may include a plurality of fluorine atoms. Thus, the fluorine particles 12 may have an extremely low index of refraction. According to an embodiment, the low index of refraction of the low refractive index layer 20 may be realized by the fluorine particles 12. For example, the fluorine particles 12 may bleed to the surface of the coating layer, and when the surface of the coating layer is fully filled with the fluorine particles 12, bleeding-out of the fluorine particles 12 may be terminated. The fluorine particles 12 that do not bleed to the surface of the coating layer may repel the fluorine particles 12 on the surface of the coating layer, and thus may stay inside the coating layer. The fluorine particles 12 inside the coating layer may be inside the low refractive index layer 20 after silica conversion of the polysilazane, and may help reduce the index of refraction of the low refractive index layer 20. For example, the fluorine particles 12 may primarily bleed to the surface of the coating layer, rather than staying inside the coating layer. In an implementation, the fluorine particles 12 that cannot bleed to the surface of the coating layer may stay inside the coating layer.

The fluorine particles 12 may have an average particle diameter of about 30 nm or less, e.g., about 20 nm or less or about 5 nm to about 15 nm. Within this range, the low refractive index layer 20 may exhibit improved strength. For example, the fluorine particles 12 may be a robust bulk body, and the fluorine particles 12 may exhibit lower strength than silica converted from the polysilazane. Thus, the fluorine particles 12 (occupying the low refractive index layer) may have as low a volume as possible. In an implementation, the fluorine particles 12 may have an average particle diameter of about 30 nm or less. Within this range, the fluorine particles 12 may exhibit improved bleed-out properties, and the protective layer 30 may have improved properties in terms of antifouling properties and scratch resistance.

Here, the average particle diameter is an arithmetic mean of particle diameters (diameters when assuming that the fluorine particles 12 are sphere particles) of the fluorine particles 12. The diameter of the fluorine particles 12 may be measured, e.g., by a laser diffraction/scattering particle size analyzer (HORIBA LA-920). The average particle diameter was measured by HORIBA LA-920 in the Examples and Comparative Examples.

In an implementation, the fluorine particles 12 may have a suitable surface tension that is lower than that of the solvent for polysilazane, and the fluorine particles 12 may have a surface tension of about 20 or less, e.g., about 18 or less or about 13 to about 17.6. Within this range, the fluorine particles 12 may have improved bleeding-out properties, and the modified silica film 1 may have improved properties in terms of antifouling properties and scratch resistance.

In an implementation, the modified silica film 1 (formed by bleeding-out of the fluorine particles 12) may have a contact angle of about 108° or more, e.g., about 110° or more. Within this range, the modified silica film 1 may have improved properties in terms of antifouling properties and scratch resistance.

In an implementation, the fluorine particles 12 may not include a reactive functional group on surfaces thereof, if possible. When the fluorine particles 12 include the reactive functional group on the surfaces thereof, there is a possibility of reaction of the reactive functional group with polysilazane. In an implementation, the fluorine particles 12 may not include the reactive functional group, and the fluorine particles 12 may be robustly retained inside the low refractive index layer 20 and the protective layer 30 due to the complicated network structure of silica.

The coating liquid 10 may have a weight ratio of the polysilazane to the fluorine particles 12 of, e.g., about 95:5 to about 60:40. Maintaining the weight ratio at about 40 or less, e.g., if an excess of the fluorine particles 12 is not present as compared with the polysilazane, may help ensure that deterioration in strength of the low refractive index layer 20 is avoided. Maintaining the weight ratio at about 5 or greater, e.g., if an excess of the polysilazane is not present as compared with the fluorine particles 12, may help ensure that the low refractive index layer 20 is sufficiently reduced in index of refraction and the protective layer 30 also has sufficient thickness.

The polysilazane may be present in an amount of about 60 parts by weight to about 95 parts by weight, e.g., about 70 parts by weight to about 90 parts by weight, and the fluorine particles 12 may be present in an amount of about 5 parts by weight to about 40 parts by weight, e.g., about 10 parts by weight to about 30 parts by weight, based on 100 parts by weight of the polysilazane and the fluorine particles 12 in the coating liquid. Within this range, it is possible to obtain effects according to the weight ratio, as described above.

Third Operation

As shown in FIG. 1, in the third operation, the coating liquid 10 may be coated onto the substrate 100. Coating may be performed by a suitable method. FIG. 1 shows die coating (in which the coating liquid 10 is coated onto the substrate 100 through a slit die 450) as one example of coating. Through the third operation, the coating layer (a layer formed of the coating liquid 10) may be formed on the substrate 100. The fluorine particles 12 in the coating layer may bleed to the surface of the coating layer, and when the surface of the coating layer is completely filled with the fluorine particles 12, bleeding-out of the fluorine particles 12 may be terminated. The fluorine particles 12 that do not bleed to the surface of the coating layer may repel the fluorine particles 12 on the surface of the coating layer and thus may stay inside the coating layer. In addition, the substrate 100 may be a film to which functions are imparted by the modified silica film. When the optical film is prepared using the modified silica film 1, the substrate 100 may be, e.g., a film including a high refractive index layer, which may be directly adjacent to the modified silica film 1.

Fourth Operation

In the fourth operation, the solvent for polysilazane may be removed from the coating liquid 10 on the substrate 100, e.g., from the coating layer. The solvent for polysilazane may be removed by, e.g., heating the coating layer to 100° C. for 1 minute.

Fifth Operation

In the fifth operation, the polysilazane may be converted into silica. If the solvent for polysilazane includes an amine catalyst, the silica conversion reaction may be performed at room temperature. If the solvent for polysilazane does not include the amine catalyst, the silica conversion reaction may be performed by, e.g., heating the coating layer to about 300° C. to about 400° C. In the coating layer, a portion in which the polysilazane is mainly distributed may become the low refractive index layer 20, and a portion in which the fluorine particles 12 are mainly distributed may become the protective layer 30. Through the above operations, the modified silica film 1 may be formed on the substrate 100. In an implementation, during silica conversion, a reaction represented by Formula 2 may be performed.

—(SiH₂NH)—+2H₂O→SiO₂+NH₃+2H₂ [Formula 2]

2. Structure and Properties of Modified Silica Film

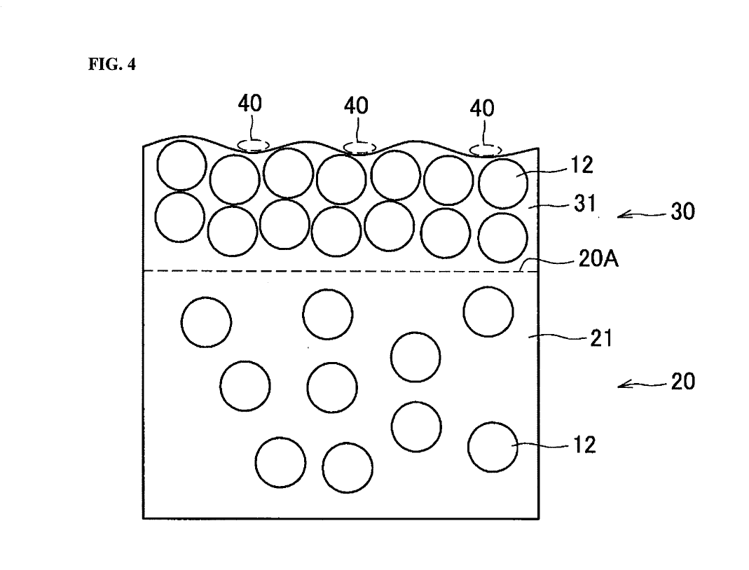

Referring to FIGS. 1 and 4, structure and properties of the modified silica film 1 will be described in detail hereinafter.

As shown in FIGS. 1 and 4, the modified silica film 1 may include the low refractive index layer 20 and the protective layer 30. The low refractive index layer 20 may include silica 21 and the fluorine particles 12. The protective layer 30 may include silica 31 and the fluorine particles 12. The fluorine particles 12 in the low refractive index layer 20 may be retained by the silica 21, and the fluorine particles 12 in the protective layer 30 may be retained by the silica 31. The silica 21, 31 may be obtained by silica conversion of polysilazane.

In an implementation, the protective layer 30 may be formed by bleeding-out of the fluorine particles 12 from inside the coating layer. For example, the method for preparing a modified silica film according to an embodiment may allow the fluorine particles 12 to be naturally or spontaneously distributed on the surface of the low refractive index layer 20, instead of intentionally distributing the fluorine particles 12 thereon as in other bi-layer coating processes.

Thus, a concentration distribution of silica (a concentration distribution of silicon atoms) and a concentration distribution of fluorine particles 12 (a concentration distribution of fluorine atoms) may be gradually changed at an interface between the low-index of refraction 20 and the protective layer 30 (a slowly varying curve depicting that a slope of concentration change per unit layer thickness may be decreased, or a slope of concentration change per unit layer thickness may have a straight line shape). For example, the silicon atom concentration per unit thickness may be almost 100 at % near the surface of the substrate 100, and the silicon atom concentration may decrease and the fluorine atom concentration may increase with increasing distance from a measurement point to the substrate 100. In an implementation, the fluorine atom concentration per unit thickness may be almost 100 at % at an uppermost surface of the protective layer, which is a maximum distance point from the surface of the substrate 100, and both atom concentrations may have the same value at a certain measurement point. Thus, the low refractive index layer may include more silica converted from the polysilazane than the protective layer. In an implementation, a plane at which both atom concentrations have the same value is an interface 20A between the low refractive index layer and the protective layer 30. At a measurement point closer to the surface of the modified silica film 1 than the interface 20A, the fluorine atom concentration may be higher than the silicon atom concentration, and at the surface of the modified silica film 1, the fluorine atom concentration may be almost 100 at %. With increasing distance from a lower surface of the low refractive index layer to an upper surface of the protective layer, the concentration of the fluorine particles may increase, and the concentration of the silica may decrease.

The fluorine particles 12 in the low refractive index layer 20 may help reduce the index of refraction of the low refractive index layer 20. The fluorine particles 12 in the protective layer 30 may help improve antifouling properties, slidability, and scratch resistance of the modified silica film 1 while reducing the index of refraction of the protective layer 30.

As shown in FIG. 4, the protective layer 30 may include protrusions and recesses on the surface thereof. For example, the surface of the modified silica film 1 may be rough (protrusions and recesses are formed on the surface thereof). For example, according to an embodiment, the fluorine particles 12 may be distributed on the surface of the modified silica film 1 by bleeding out (natural movement) of the fluorine particles 12, and the surface of the modified silica film 1, e.g., the surface of the protective layer 30 may be rough. A surface shape of the protective layer 30 may be confirmed by observation, e.g., using a scanning electron microscope (SEM) or a shape measuring laser microscope. In an implementation, the shape measuring laser microscope may acquire three-dimensional data of an overall observation view region through non-contact three-dimensional measurement on a target using a laser. The shape measuring laser microscope may be a VK-9500 (KEYENCE JAPAN Co., Ltd.).

In this way, the protrusions and recesses may be formed on the surface of the modified silica film 1. In addition, the recess may include an air layer 40 on a surface thereof. The air layer 40 may help reduce the index of refraction of the modified silica film 1. In an implementation, the air layer 40 may be present between a contaminant attached to the surface of the modified silica film 1 and the protective layer 30. Thus, when the contaminant is a liquid (e.g., a liquid component of a fingerprint), the contaminant may have a larger contact angle than another protective layer (e.g., a protective layer prepared by two-layer coating). Thus, the surface of the modified silica film 1 may exhibit reduced wettability.

In an implementation, the protrusions and recesses of the surface of the modified silica film 1 may be smooth, as the protrusions and recesses may be formed by natural movement (bleeding-out) of the fluorine particles 12. Thus, when the contaminant is a solid (for example, a wax component of a fingerprint), removal of the contaminant filling the recesses may be facilitated (e.g., the contaminant may not cling to the surface of the modified silica film 1).

Further, as shown in Examples described below, the modified silica film 1 may have an average surface roughness (Ra) of about 6.5 nm to about 15.0 nm. Maintaining the average surface roughness (Ra) at about 6.5 nm to about 15.0 nm may help ensure that the modified silica film 1 exhibits a lower index of refraction, and that the contaminant may also be increased in contact angle. Here, the average surface roughness (Ra) may be an arithmetic mean of heights of the protrusions of the protective layer 30, and the height of the protrusion may be a distance from the top of the protrusion to the bottom (a point closest to the low refractive index layer 20) of the recess adjoining the protrusion. These values may be measured by the shape measuring laser microscope. In the Examples and Comparative Examples, the average surface roughness was measured using a VK-9500 (KEYENCE JAPAN Co., Ltd.).

The low refractive index layer may have a thickness corresponding to, e.g., that is, about 80% to about 99.8% of a total thickness of the modified silica film, and the protective layer may have a thickness corresponding to, e.g., that is, about 0.2% to about 20% of the total thickness of the modified silica film. The modified silica film may have a total thickness of about 1 μm to about 100 μm.

The silica may be present in an amount of about 60 wt % to about 95 wt %, e.g., about 70 wt % to about 90 wt %, and the fluorine particles may be present in an amount of about 5 wt % to about 40 wt %, e.g., about 10 wt % to about 30 wt %, based on a sum of the silica and the fluorine particles 12 in the modified silica film. Within this range, the modified silica film may exhibit antifouling properties, slidability, and scratch resistance.

The modified silica film may have a pencil hardness of H or harder, e.g., from H to 2H, and a contact angle of about 110.3° or more, e.g., from about 110.3° to about 112°.

The modified silica film may have a minimum reflectance of about 3.5% or less, e.g., from about 1.0% to about 3.5%.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### EXAMPLES

### Example 1

In Example 1, a modified silica film was prepared by the following preparation method.

As an undiluted solution of a polysilazane solution, NAX120-20 (AZ Electronic Materials Co., Ltd.) was prepared. Hereinafter, the undiluted solution will also be referred to as an “undiluted polysilazane solution”. The undiluted polysilazane solution contained 20 wt % of polysilazane. In addition, a solvent for the undiluted polysilazane solution was dibutyl ether (surface tension of 22.4) and included an amine catalyst.

In addition, as a fluorine particle solution, FX-012 (Nissan Chemical Industries, Ltd.) was prepared. Hereinafter, the fluorine particle solution was also referred to as an “undiluted fluorine particle solution”. The undiluted fluorine particle solution included 5 wt % of fluorine particles. In addition, a solvent for the undiluted fluorine particle solution was dibutyl ether. The fluorine particles had a surface tension of 17.6, and an average particle diameter of about 10 nm. The fluorine particles did not include a reactive functional group.

Next, 2 parts by weight of the undiluted fluorine particle solution was added to 9.5 parts by weight of the undiluted polysilazane solution, followed by stirring for 10 minutes, thereby preparing a liquid mixture. Next, a predetermined amount of dibutyl ether was added to the liquid mixture, followed by slowly stirring the mixture for 10 minutes, thereby preparing a coating liquid. Here, the amount of the dibutyl ether added to the liquid mixture was determined such that solids (polysilazane+fluorine particles) were present in an amount of 2 parts by weight in the coating liquid. That is, the coating liquid included 2 parts by weight of solids (polysilazane+fluorine particles) and 98 parts by weight of solvent.

Next, the coating liquid was coated onto a poly(methyl methacrylate) (PMMA) substrate such that the modified silica film had a thickness of about 100 nm. Coating was performed using a wire bar. In this way, a coating layer was prepared. As described above, the fluorine particles in the coating layer bled to a surface of the coating layer. Next, the coating layer was heated to 100° C. for 1 minute, thereby removing the solvent from the coating layer. All of the processes were performed under a nitrogen atmosphere.

Next, the coating layer was left at room temperature (23° C., 54% RH) for one week, thereby performing silica conversion of the polysilazane. Thus, the modified silica film was prepared.

### Examples 2 to 5 and Comparative Examples 1 and 2

In Examples 2 to 5 and Comparative Examples 1 and 2, the same processes as in Example 1 were performed except that a weight ratio of polysilazane to fluorine particles was modified, as shown in Table 1, below.

### Comparative Examples 3 and 4

In Comparative Examples 3 and 4, the same processes as in Example 1 were performed, except that a reactive fluorine polymer (in a liquid state) was used instead of the undiluted fluorine particle solution, and that the polysilazane and the reactive fluorine polymer had a weight ratio of 90:10. Here, the reactive fluorine polymer reduced an index of refraction of a low refractive index layer. However, the reactive fluorine polymer included a functional group (silanol group) that reacted with polysilazane. Table 1 shows the amounts of solids, and the weight ratios of polysilazane to fluorine particles according to Examples 1 to 5 and Comparative Examples 1 to 4, respectively.

TABLE 1

| | | Constitution (wt %) | |
|---|---|---|---|
| | Solids in solution (wt %) | Polysilazane | Fluorine particles |
| Example 1 | 2 | 95 | 5 |
| Example 2 | 2 | 90 | 10 |
| Example 3 | 2 | 80 | 20 |
| Example 4 | 2 | 70 | 30 |
| Example 5 | 2 | 60 | 40 |
| Comparative | 2 | 100 | 0 |
| Example 1 | | | |
| Comparative | 2 | 50 | 50 |
| Example 2 | | | |
| Comparative | 2 | 90 | 10 1 |
| Example 3 | | | |
| Comparative | 2 | 90 | 10 2 |
| Example 4 | | | |

 1 represents KY-108 (a surface tension of 16.5, Shin-Etsu Chemical Co., Ltd.), and
 2 represents KY-164 (a surface tension of 16.1, Shin-Etsu Chemical Co., Ltd.). Unmarked cases represent FX-012 (Nissan Chemical Industries, Ltd.).

In Examples 1 to 5, a difference in surface tension between the solvent for polysilazane and the fluorine particles was 4.5 or more, as calculated by subtracting the surface tension of the fluorine particles from the surface tension of the solvent for polysilazane. In addition, referring to Table 1, in Examples 1 to 5, the weight ratio of the polysilazane to the fluorine particles had a value according to an embodiment. Further, in Comparative Example 1, the silica film was formed only in a single layer (the protective layer was not formed).

Evaluation of Minimum Reflectance

Minimum reflectance (%) of the modified silica film was measured. Measurement was performed by absolute reflectance measurement using a spectrophotometer UV-2550 (SHIMADZU Co., Ltd.). An incident light angle was set to 5°. The minimum reflectance is a parameter corresponding to an index of refraction of the modified silica film and the minimum reflectance is proportional to the index of refraction.

Evaluation of Contact Angle (CA)

2 μl of pure water was dropped onto the exposed surface of the modified silica film to measure a contact angle using an automated contact angle analyzer DM700 (Kyowa Interface Science Co., Ltd.). The contact angle is a parameter having an influence on antifouling properties and slidability of the modified silica film.

Evaluation of Average Surface Roughness

Average surface roughness (Ra) of the modified silica film before wipe testing was measured using a VK-9500 (KEYENCE JAPAN Co., Ltd.).

Pencil Rubbing Test

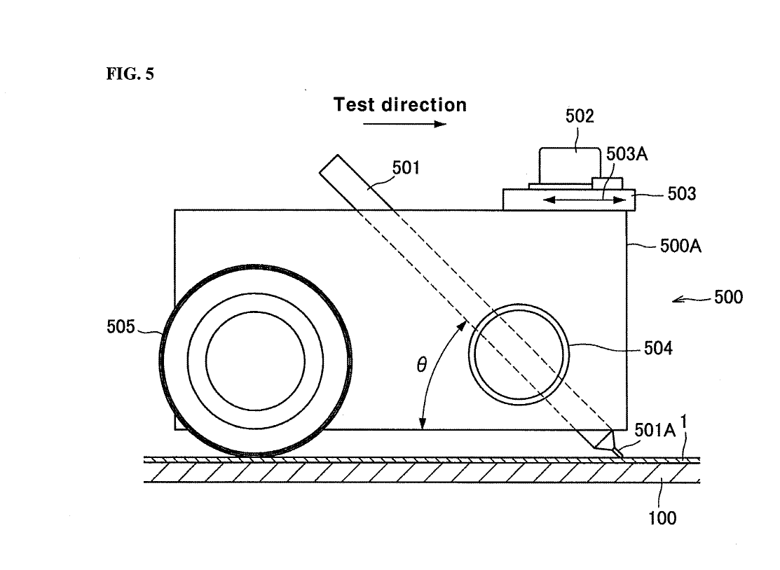

To evaluate strength of the modified silica film, a pencil rubbing test was performed in accordance with JIS-K-5600. Referring to FIG. 5, a tester 500 used in the pencil rubbing test will be described in detail. FIG. 5 shows a situation in which the pencil rubbing test is performed on the modified silica film 1 according to an embodiment using the tester 500. Strength of the modified silica film is a parameter having an influence on scratch resistance of the modified silica film.

The tester 500 includes a main body 500A, a level 502, a small movable weight 503, a clamp 504, and an O-ring 505. The main body 500A may have a through-hole, into which a pencil 501 is inserted. An angle between a longitudinal direction of the pencil 501 inserted into the through-hole and a lower surface (e.g., a surface of the modified silica film 1) of the main body 500A is 45 degrees. The level 502 is a component for confirming horizontality of the main body 500A. The small movable weight 503 is a component for adjusting load applied to a core 501A of the pencil 501. The small movable weight 503 may be moved in a direction of Arrow 503A. The clamp 504 secures the pencil 501 inside the main body 500A. The O-ring 505 is rotatably attached to the main body 500A. The O-ring 505 is rolled on the modified silica film 1, thereby moving the tester 500 in a test direction.

Next, a method for the pencil rubbing test will be described in detail. Here, the method for the pencil rubbing test will be described by way of example of the pencil rubbing test of the modified silica film 1 (formed on a substrate 100) according to an embodiment.

First, the pencil 501 is inserted into the tester 500 and then secured. Next, the core of the pencil 501 is pressed down on the modified silica film 1. Next, horizontality of the tester 500 is confirmed using the level 502. Next, a position of the small movable weight 503 is adjusted, thereby applying a load of 500 g to the core 501A of the pencil 501. Next, the tester 500 is moved at a speed of 0.8 mm/sec in the test direction, as shown in FIG. 5. As a result, the core 501A of the pencil 501 rubs the surface of the modified silica film 1. Through the above operation, the pencil rubbing test is performed. Next, occurrence of scratches is observed by the naked eye. When scratches are observed, hardness of the core 501A of the pencil 501 is reduced to perform the pencil rubbing test again. When the scratches are not observed, hardness of the core 501A of the pencil 501 is increased to perform the pencil rubbing test again. In addition, maximum hardness (pencil hardness), at which scratches are not observed, is measured. The hardness is a criteria for showing strength (scratch resistance) of the modified silica film 1. The pencil hardness is, in increasing order of hardness, 2H>H>F>HB>B.

### Comparison of Examples and Comparative Examples

Results of the above test and evaluation are shown in Table 2.

TABLE 2

| | Evaluation result | | | |
|---|---|---|---|---|
| | Minimum | Pure | Pencil | Average surface |
| | reflectance (%) | CA (°) | hardness | roughness Ra (nm) |
| Example 1 | 3.39 | 110.3 | H | 6.9 |
| Example 2 | 3.02 | 111 | 2H | 8.3 |
| Example 3 | 2.53 | 111.1 | 2H | 10.5 |
| Example 4 | 2.15 | 111.2 | 2H | 12.3 |
| Example 5 | 1.83 | 111.6 | H | 14.7 |
| Comparative | 3.58 | 61.3 | F | 1.9 |
| Example 1 | | | | |
| Comparative | 1.32 | 112.3 | HB | 16.8 |
| Example 2 | | | | |
| Comparative | 3.39 | 109.2 | HB | 7.7 |
| Example 3 | | | | |
| Comparative | 3.18 | 109.7 | HB | 8.3 |
| Example 4 | | | | |

Minimum Reflectance

In comparison of the modified silica films of the Examples with those of the Comparative Examples, all the modified silica films of the Examples had a minimum reflectance less than or equal to the minimum reflectance of the modified silica films of the Comparative Examples. The modified silica film of Example 1 had the same minimum reflectance as that of the modified silica film of Comparative Example 3. However, the amount of the reactive fluorine polymer in the modified silica film of Comparative Example 3 was twice the amount of the fluorine particles in the modified silica film of Example 1, and the minimum reflectance of the modified silica film in Example 1 became lower than that of the modified silica film in Comparative Example 3 in the same amount.

As a first reason, the average surface roughness (Ra) may be considered. In the Examples, the modified silica films had an average surface roughness (Ra) ranging from 6.5 nm to 15.0 nm, and it may be considered that the indexes of refraction of the modified silica films were reduced due to the aforementioned air layer.

However, the modified silica films of Comparative Examples 3 and 4 had an average surface roughness (Ra) ranging from 6.5 nm to 15.0 nm. For example, the reactive fluorine polymer also exhibited low surface tension, and thus bled to the surface of the coating layer. As a result, it may be assumed that the modified silica films had a rough surface.

As a second reason, it may be considered that the modified silica films of the Examples had reduced volume density. For example, in the modified silica films of the Examples, the fluorine particles having a large number of pores were dispersed. Conversely, the reactive fluorine polymer of the modified silica films of Comparative Examples 3 and 4 had a chain structure. In addition, the reactive fluorine polymer reacted with the polysilazane in the coating liquid. The volume density of the modified silica film was increased at a reaction site of the reactive fluorine polymer and the polysilazane. Thus, it may be assumed that the modified silica films of Examples had a lower volume density than the modified silica films of Comparative Examples 3 and 4. Further, as the modified silica film had a lower volume density, the modified silica film had a lower index of refraction since the modified silica film included a large amount of air therein. Due to the above reasons, it may be assumed that the modified silica films of the Examples had lower indexes of refraction than the modified silica films of Comparative Examples 3 and 4.

Contact Angle

In comparison of the modified silica films of Examples 1 to 5 with that of Comparative Example 1, the modified silica films of Examples 1 to 5 exhibited a better contact angle than that of Comparative Example 1. In Examples 1 to 5, it may be assumed that since the protective layer was formed on the surface of the low refractive index layer, the modified silica films exhibited good contact angle due to the protective layer. In addition, the modified silica films of Comparative Examples 2 to 4 also exhibited good contact angle. Thus, it may be assumed that the protective layer was also formed due to the fluorine particles or the reactive fluorine polymer in Comparative Examples 2 to 4. However, the modified silica films of Comparative Examples 2 to 4 exhibited a lower index of refraction and strength (pencil hardness) than any other modified silica films of Examples.

Pencil Hardness

In comparison of the modified silica films of Examples 1 to 5 with that of Comparative Example 1, the modified silica films of Examples 1 to 5 exhibited higher strength (pencil hardness) than the modified silica film of Comparative Example 1. Thus, in Examples 1 to 5, it may be seen that the protective layer was formed due to the fluorine particles, and that the modified silica films had improved strength due to the protective layer. In addition, it may be seen that the weight ratio of the fluorine particles had a lower limit of 5. In comparison of the modified silica films of Examples 1 to 5 with that of Comparative Example 2, the modified silica films of Examples 1 to 5 exhibited higher strength (pencil hardness) than the modified silica film of Comparative Example 2. Thus, it may be seen that the weight ratio of the fluorine particles had an upper limit of 40.

In addition, in comparison of the modified silica films of Examples 1 to 5 with that of Comparative Examples 3 and 4, the modified silica films of Examples 1 to 5 exhibited higher strength (pencil hardness) than the modified silica films of Comparative Examples 3 and 4. In Comparative Examples 3 and 4, it may be assumed that the modified silica films suffered from white turbidity since the reactive fluorine polymer reacted with the polysilazane in the coating liquid, and that the modified silica films were deteriorated in crosslinking density. Conversely, in Examples 1 to 5, the reactive fluorine polymer did not react with the polysilazane in the coating liquid. Thus, it may be assumed that the modified silica films of Examples 1 to 5 exhibited a higher crosslinking density than the modified silica films of Comparative Examples 3 and 4.

From the results of the Examples and Comparative Examples, it may be confirmed that the modified silica film according to an embodiment exhibited a lower index of refraction and higher strength than other modified silica films.

By way of summation and review, the silica film may be used for a low refractive index layer of an optical film. The optical film may be, e.g., an anti-reflective film attached to a surface of a display.

To us the silica film for the low refractive index layer, the silica film may have a reduced index of refraction. A method for reducing the index of refraction of the silica film may include adding a water and oil repellency imparting agent to polysilazane, followed by silica conversion of the polysilazane. The water and oil repellency imparting agent may be a reactive fluorine polymer having a bonding group that is bondable to the polysilazane.

Polysilazane is very reactive, and when a reactive fluorine resin is added thereto, the polysilazane may react with the reactive fluorine polymer prior to silica conversion of the polysilazane. In addition, a reaction site of the polysilazane that reacts with the reactive fluorine polymer may not be cross-linked with a surrounding silica skeleton upon silica conversion. Thus, a modified silica film may be deteriorated in crosslinking density and strength. Thus, the modified silica film may exhibit reduced or inferior strength. Further, reaction of the reactive fluorine polymer with the polysilazane may be observed by deterioration in strength of the modified silica film. Some of the reactive fluorine polymers may cause white turbidity of a polysilazane solution through reaction with the polysilazane, and reaction of the reactive fluorine polymer with the polysilazane may also be observed by the presence of such white turbidity.

A method may be used to prepare a film in which a high refractive index layer exhibits a higher index of refraction than that of the silica film. For example, the optical film may include both the high refractive index layer and the low refractive index layer. Thus, in such a method, the high refractive index layer may exhibit a higher index of refraction than that of the silica film, and the silica film may function as the low refractive index layer. However, materials for the high refractive index layer may be limited.

The embodiment may provide a method for preparing a modified silica film, which has a lower index of refraction and higher strength than other silica films.

By the method according to an embodiment, a modified silica film exhibiting higher strength (scratch resistance) and a lower index of refraction than other modified silica films may be prepared. Further, the modified silica film may be used as a low refractive index layer of an optical film, thereby widening choice of materials for a high refractive index layer.

The fluorine particles in the coating layer may bleed to or aggregate at a surface of the coating layer. Thus, a protective layer may be formed on a surface of the low refractive index layer. Thus, the modified silica film may have improved properties in terms of antifouling properties, slidability, and scratch resistance.

In addition, bleeding-out or aggregation may naturally occur, and the modified silica film, e.g., the low refractive index layer and the protective layer, may be formed by simply coating the coating liquid onto the substrate in one layer. Thus, the one-packing type modified silica film may be easily prepared.

In the method according to an embodiment, the fluorine particles may have a large number of pores. Thus, the index of refraction of the modified silica film may be reduced. In addition, the fluorine particles may form a robust bulk body, and the modified silica film may exhibit improved properties in terms of antifouling properties, slidability, and scratch resistance.

According to an embodiment, fluorine particles in the coating layer may repel the polysilazane. For example, reaction of the polysilazane with the fluorine particles may be suppressed, and a modified silica film prepared using the coating liquid may exhibit improved crosslinking density of silica, as compared with other modified silica films, and improved strength. Thus, a modified silica film exhibiting higher strength (scratch resistance) and a lower index of refraction than other silica films may be prepared. The modified silica film may be used as a low refractive index layer of an optical film, thereby widening choices of materials for a high refractive index layer.

The modified silica film according to an embodiment may include silica having a higher crosslinking density and fluorine particles having a lower index of refraction than other modified silica films, and the modified silica film may exhibit higher strength (scratch resistance) and a lower index of refraction than the other silica films.

The modified silica film may include the protective layer including the fluorine particles, and the modified silica film may have improved properties in terms of antifouling properties, slidability, and scratch resistance.

As described above, according to the embodiments, the coating liquid 10 may be prepared by mixing the polysilazane solution 11 with the fluorine particles 12. In addition, the coating layer may be formed by coating the coating liquid 10 onto the substrate 100. The fluorine particles 12 in the coating layer may repel the polysilazane. For example, a reaction of the polysilazane with the fluorine particles may be suppressed. Thus, according to the embodiments, the modified silica film 1 may exhibit improved crosslinking density of the silica, as compared with other modified silica films, and may have improved strength. Thus, according to the embodiments, the modified silica film 1, which may exhibit higher strength (scratch resistance) and a lower index of refraction than other modified silica films, may be prepared. Further, the modified silica film 1 may exhibit a lower index of refraction than other modified silica films, the modified silica film 1 may be used as a low refractive index layer of an optical film, thereby widening choices of materials for the high refractive index layer.

In addition, the fluorine particles 12 may exhibit lower surface tension than the solvent for polysilazane, and the fluorine particles 12 in the coating layer may bleed to the surface of the coating layer. As a result, the protective layer 30 may be formed on the surface of the low refractive index layer 20. Thus, according to the embodiments, the modified silica film 1 may have improved properties in terms of antifouling properties, slidability, and scratch resistance.

Further, according to the embodiments, bleeding out of the fluorine particles may naturally occur, and the modified silica film 1, e.g., the low refractive index layer 20 and the protective layer 30, may be formed just by coating the coating liquid 10 onto the substrate 100 in one layer. As a result, the modified silica film 1 may be easily prepared.

Furthermore, the fluorine particles 12 may be a multi-branched fluorine polymer and thus may have a large number of pores. Thus, according to the embodiments, the modified silica film 1 may be further reduced in index of refraction. In addition, the fluorine particles may form a robust bulk body, and the modified silica film 1 may have improved properties in terms of antifouling properties, slidability, and scratch resistance.

Furthermore, the modified silica film 1 may have an average surface roughness from 6.5 nm to 15.0 nm, and the modified silica film 1 may be further reduced in index of refraction.

Furthermore, a difference in surface tension between the solvent for polysilazane and the fluorine particles 12 may be 4.5 or more, as calculated by subtracting the surface tension of the fluorine particles from the surface tension of the solvent, and the fluorine particles 12 may efficiently bleed to the surface of the coating layer.

Furthermore, the solvent for polysilazane may include at least one selected from the group of dibutyl ether, xylene, mineral turpentine, petroleum hydrocarbons, and high-boiling point aromatic hydrocarbons. Thus, the fluorine particles 12 may efficiently bleed to the surface of the coating layer.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A method for preparing a one-packing type modified silica film, the method comprising:
providing a polysilazane solution, the polysilazane solution having polysilazane dissolved in a solvent for polysilazane;
providing a coating liquid by mixing fluorine-containing particles in the polysilazane solution, the fluorine-containing particles having a non-reactive functional group that does not react with polysilazane;
forming a coating layer by coating the coating liquid onto a substrate;
removing the solvent for polysilazane from the coating layer, and
converting the polysilazane into silica.

2. The method as claimed in claim 1, wherein the fluorine-containing particles have a lower surface tension than the solvent for polysilazane.

3. The method as claimed in claim 1, wherein the fluorine-containing particles include a multi-branched fluorine polymer.

4. The method as claimed in claim 1, wherein a weight ratio of the polysilazane to the fluorine-containing particles is about 95:5 to about 60:40.

5. The method as claimed in claim 1, wherein the non-reactive functional group is a (per)fluoroalkyl group or a (per)fluoropolyether group.

6. A one-packing type modified silica film prepared by the method as claimed in claim 1.

7. A one-packing type modified silica film, comprising:
a low refractive index layer, the low refractive index layer including silica that has been converted from polysilazane and fluorine-containing particles having a non-reactive functional group that does not react with polysilazane.

8. The modified silica film as claimed in claim 7, further comprising a protective layer on a surface of the low refractive index layer, the protective layer having a higher concentration of the fluorine-containing particles than the low refractive index layer.

9. The modified silica film as claimed in claim 8, wherein the protective layer has an average surface roughness of about 6.5 nm to about 15.0 nm.

10. The modified silica film as claimed in claim 8, wherein a concentration of the fluorine-containing particles in the modified silica film increases as a distance from a lower surface of the low refractive index layer to an outer surface of the protective layer increases.

11. The modified silica film as claimed in claim 8, wherein:
the protective layer includes silica that has been converted from polysilazane, and
the low refractive index layer includes a greater amount of silica than the protective layer.

12. The modified silica film as claimed in claim 8, wherein a concentration of the silica in the modified silica film decreases as a distance from a lower surface of the low refractive index layer to an outer surface of the protective layer increases.

13. The modified silica film as claimed in claim 8, wherein the modified silica film includes about 60 wt % to about 95 wt % of the silica, and about 5 wt % to about 40 wt % of the fluorine-containing particles.

14. The modified silica film as claimed in claim 8, wherein:
the low refractive index layer has a thickness that is about 80% to about 99.8% of a total thickness of the modified silica film, and
the protective layer has a thickness that is about 0.2% to about 20% of the total thickness of the modified silica film.

15. The modified silica film as claimed in claim 7, wherein the modified silica film has:
a pencil hardness of H or harder, and
a contact angle of about 110.3° or higher.

16. The modified silica film as claimed in claim 7, wherein the modified silica film is prepared from a coating liquid, the coating liquid including the fluorine-containing particles and a polysilazane solution prepared by dissolving polysilazane in a solvent for polysilazane, the fluorine-containing particles having a lower surface tension than the solvent for polysilazane.

17. The modified silica film as claimed in claim 16, wherein a weight ratio of the polysilazane to the fluorine-containing particles in the coating liquid is about 95:5 to about 60:40.

18. The modified silica film as claimed in claim 16, wherein a difference in surface tension between the solvent for polysilazane and the fluorine-containing particles is about 3.8 mN/m or more.
